(19) United States
(12) Patent Application Publication
(10) Pub. No.: US 2024/0185061 A1
(43) Pub. Date: Jun. 6, 2024

(54) COMPUTER-READABLE RECORDING MEDIUM STORING MACHINE LEARNING PROGRAM, MACHINE LEARNING METHOD, AND INFORMATION PROCESSING APPARATUS

(71) Applicant: Fujitsu Limited, Kawasaki-shi (JP)

(72) Inventor: Yuichiro WADA, Setagaya (JP)

(73) Assignee: Fujitsu Limited, Kawasaki-shi (JP)

(21) Appl. No.: 18/241,262

(22) Filed: Sep. 1, 2023

(30) Foreign Application Priority Data
Nov. 29, 2022 (JP) 2022-190578

(51) Int. Cl. G06N 3/08

(52) U.S. Cl. CPC G06N 3/08

(57) ABSTRACT

A computer-readable recording medium stores a machine learning program for causing a computer to execute a process. The process includes: in training a machine learning model that performs clustering of a data group, generating a second optimization function by converting a first optimization function that uses normalized cut (NCut) based on an introduction of a neural network and a uniform assumption for a cluster in the clustering; and executing the training of the machine learning model by executing processing of optimizing the second optimization function.

### CROSS-REFERENCE TO RELATED APPLICATION

This application is based upon and claims the benefit of priority of the prior Japanese Patent Application No. 2022-190578, filed on Nov. 29, 2022, the entire contents of which are incorporated herein by reference.

### FIELD

The embodiments discussed herein are related to a computer-readable recording medium storing a machine learning program, a machine learning method, and an information processing apparatus.

### BACKGROUND

Artificial intelligence (AI) has been utilized in various fields in recent years, and is used for clustering for classifying (grouping) data based on a similarity between pieces of data, for example.

The clustering is a type of unsupervised learning in machine learning. For example, when an unlabeled data set (configured by n data points or feature vectors) and a number C of clusters thereof are given, the data set is divided into C subsets in the clustering.

As a clustering method for a data set having a low-dimensional simple manifold structure, for example, a K-equal method, Gaussian mixture distribution clustering, and spectral clustering are known. The spectral clustering is also used as a clustering method for a data set having a low-dimensional complex manifold structure.

The simple manifold structure refers to a manifold structure formed by a Gaussian mixture model or a data set approximate to the Gaussian mixture model. Conversely, the complex manifold structure refers to a structure of a manifold other than a simple manifold. The “low dimension” represents a dimension of about two to three dimensions.

In the spectral clustering, an eigenvalue problem related to W-defined by the following Expression (a) is solved, and eigenvectors corresponding to top C eigenvalues in terms of magnitude are arranged to define an n×C matrix.

W⁻=D^{-1/2}WD^{-1/2} (a).

It is assumed that an i-th row of the defined matrix is x^{-hd i}i. x⁻ᵢ may be interpreted as a low-dimensional representation of a data point xᵢ. A set {xᵢ}ⁿi=1 of the low-dimensional representation is considered. The K-equal method is performed on these with K=C to obtain a cluster level.

U.S. Patent Application Publication Nos. 2019/0347567 and 2017/0200092, Japanese Laid-open Patent Publication No. 2021-193564, and International Publication Pamphlet No. WO 2022/009254 are disclosed as related art.

### SUMMARY

According to an aspect of the embodiments, a computer-readable recording medium storing a machine learning program for causing a computer to execute a process, the process including: in training a machine learning model that performs clustering of a data group, generating a second optimization function by converting a first optimization function that uses normalized cut (NCut) based on an introduction of a neural network and a uniform assumption for a cluster in the clustering; and executing the training of the machine learning model by executing processing of optimizing the second optimization function.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of an information processing apparatus according to an example of an embodiment;

FIG. 2 is a block diagram illustrating a hardware configuration of a computer that realizes functions of the information processing apparatus as the example of the embodiment;

FIG. 3 is a diagram for explaining a flow of learning processing by the information processing apparatus as the example of the embodiment;

FIG. 4 is a flowchart for explaining learning processing of a statistical model by the information processing apparatus as the example of the embodiment; and

FIG. 5 is a diagram illustrating respective clustering results in a case where a plurality of methods are used.

### DESCRIPTION OF EMBODIMENTS

As described above, in the spectral clustering, the eigenvalue problem related to W defined by Expression (a) is solved. When W- is represented as an n×n matrix, O (n³) is taken for a calculation time. Accordingly, for example, it takes an enormous amount of time to execute the spectral clustering on a large-scale data set such as n 32 10⁷ to 10⁹, and it is substantially impossible to execute the spectral clustering. O (·) is an order.

According to one aspect, an object of the present disclosure is to shorten a time taken for machine learning.

Hereinafter, an embodiment of a machine learning program, a machine learning method, and an information processing apparatus will be described with reference to the drawings. The embodiment described below is merely an example and is not intended to exclude various modification examples or applications of techniques that are not explicitly described in the embodiment. For example, the present embodiment may be variously modified and implemented within a scope not departing from the gist thereof. The drawings are not provided with an intention that only the constituent elements illustrated in the drawings are included. Other functions and the like may be included.

(A) Related Technique

As described above, it takes an enormous amount of time to execute the spectral clustering on the large-scale data set, and it is substantially impossible to execute the spectral clustering. Even in a case where a system that causes the spectral clustering to be executed on the large-scale data set is implemented, high-accuracy clustering may not be performed by the spectral clustering on a data set having a high-dimensional simple manifold structure. This is because a larger number of data points are desired to grasp a cluster structure as a dimension becomes higher.

Accordingly, a method is conceivable in which information maximizing self augmented training (IMSAT), which is an unsupervised classification method, is combined with a constraint for causing a statistical model to learn a manifold structure of a data set X={xᵢ}ⁿi=1 composed of n feature vectors. For convenience, the method may be referred to as mutual information maximization via local smoothness and topological invariant constraints (MIST).

According to the MIST, first, a function of mutual information (MI) indicated by the following Expression (1) is generated by using the number of clusters in clustering to be executed and a statistical model. The mutual information is an amount representing a degree of mutual dependence between a certain data point and its class label.

_{η}H (Y) . . . H (Y|X) (1)

X represents a data set, and Y represents a set of class labels y given to each data point x included in the data set X. H (Y) represents an entropy of a distribution of prediction results in the entire data set. H (Y|X) represents an entropy of a distribution of prediction results in individual prediction. η is a hyper parameter for adjustment. Expression (1) represents a mutual information between the data point x and the class label y of the data point. By maximizing H (Y), the same class label is given to data points close to each other. By reducing H (Y|X), data points having the same class label are collected in close areas.

In the MIST, by using the number of clusters in the clustering to be executed and the statistical model, a function for SAT represented by Expression (2) indicated below is generated. θ is a parameter of a neural network included in the statistical model. The SAT is processing for smoothing a distribution, and is also referred to as virtual adversarial training (VAT).

[symbol]

_{x˜p(x)}[Rᵥₐₜ(X; θ)]≤δ₁ (2)

In the MIST, by using the number of clusters in clustering to be executed and the statistical model, an inter-pair force function for representing a force between two data points forming a pair, which is indicated by the following Expression (3), is generated.

$$\frac{1}{\vert B \vert} {\sum }_{{x}_{i} ∈ B} log \frac{{e}^{q ( {g}_{θ} ( {x}_{i} ) , {g}_{θ} ( {t}_{i} ( {x}_{i} ) ) )}}{\frac{1}{\vert B \vert} {Σ}_{{x}_{j} ∈ B} {e}^{q ( {g}_{θ} ( {x}_{i} ) , {g}_{θ} ( {t}_{j} ( {x}_{j} ) ) )}} \qquad ( 4 )$$

I_{nce} is a loss based on noise contrasting estimation called noise contrastive estimation (InfoNCE), and is given by the following Expression (4).

$${M}^{′} - {δ}_{2}^{′} \leq \frac{{I}_{nce} + I {′}_{nce}}{2} \geq {M}^{′} \qquad ( 3 )$$

q is a function that defines a similarity between two probability vectors. I′_{nce} is given by the following Expression (5).

$$\frac{1}{\vert B \vert} {\sum }_{{x}_{i} ∈ B} log \frac{{e}^{q ( {g}_{θ} ( {t}_{i} ( {x}_{i} ) , {g}_{θ} ( {x}_{i} ) )}}{\frac{1}{\vert B \vert} {Σ}_{{x}_{j} ∈ B} {e}^{q ( {g}_{θ} ( {t}_{i} ( {x}_{i} ) , {g}_{θ} ( {x}_{j} ) )}} \qquad ( 5 )$$

When Expression (4) is represented as InfoNCE (g_{θ} (x), g_{θ} (t (x))) as a function of g_{θ} (x) and g_{θ} (t (x)), Expression (5) is represented as InfoNCE (g_{θ} (t (x)), g_{θ} (x)). InfoNCE (g_{θ} (x), ge (t (x))) do not have symmetry with respect to g_{θ} (x) and g_{θ} (t (x)). Accordingly, by adding I_{nce} and I′_{nce} obtained by reversing the parameter at I_{nce} and dividing the sum by 2, a function is generated in which the loss based on the noise contrasting estimation has the symmetry.

By substituting Expressions (4) and (5) into Expression (3) and organizing the expressions, the following Expression (6) is obtained.

Here,

$$- log \vert B \vert - \frac{1}{\vert B \vert} {\sum }_{{x}_{i} ∈ B} q ( {g}_{θ} ( {x}_{i} ) , {g}_{θ} ( {t}_{i} ( {x}_{i} ) ) ) + \frac{1}{2 \vert B \vert} {\sum }_{{x}_{i} ∈ B} log ( {\sum }_{{x}_{i} ∈ B} {\sum }_{{x}_{i} ∈ B} {e}^{α ( {u}^{′} j )} ) \qquad ( 6 )$$

q(z, z′)=log (exp_{α}(τ(z^{T}z′−1)))
Where, a ∈ R, and T≥0,
when a≠1, expₐ (s) is defined as [1+(1−a)s]^{1/(1-a)}+, and
when a=1, it is defined as expₐ (s)=exp (s).
[·]₊ is max {·, 0}.

The MIST is formulated by a constrained optimization problem indicated by Expressions (1), (2), and (3). According to the MIST, the statistical model is learned so as to maximize a mutual information function indicated by Expression (1) while Expressions (2) and (3) are satisfied. For example, the mutual information between the data point and the class label is maximized while an inter-distribution distance related to the class label of the data point of which two Euclidean distances are close to each other is minimized and a condition for maximizing an inter-pair function is satisfied. By maximizing the inter-pair function, an attractive force between pairs of data points belonging to the same manifold is increased, and a repulsive force between pairs of data points belonging to different manifolds is decreased.

Accordingly, in the MIST, it is possible to clearly classify each of the data points belonging to different manifolds into different clusters.

However, in such a MIST, the number of hyper parameters (λ, η, μ, a, T) is as large as five, and adjustment of these hyper parameters takes cost.

Hyper parameters λ and μ appear in an optimization problem to be indicated below. This optimization problem is obtained by converting the constrained optimization problem indicated by Expressions (1), (2), and (3) into unconstrained optimization by using a penalty method.

θ*=argmin_{θ}[Rᵥₐₜ(B; θ)−μ{ηH(Y)−H(Y|X)−γ(Lₚₛ+L_{ng})}]

Minimization of Lₚₛ+L_{ng} is equivalent to maximization of (I_{nce}+I′_{nce})/2.

According to the present information processing apparatus, a clustering method that makes adjustment of the hyper parameters easier than the MIST is realized.

(B) Configuration

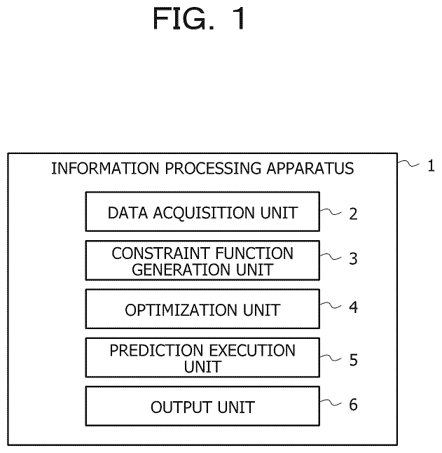

FIG. 1 is a diagram illustrating a functional configuration of an information processing apparatus 1 as an example of the embodiment.

The information processing apparatus 1 performs training of a machine learning model for performing clustering of data groups. The machine learning model may be a neural network (NN). The information processing apparatus 1 may perform clustering (prediction) of data by using a trained machine learning model. The machine learning model may be referred to as a statistical model.

(B-1) Hardware Configuration Example

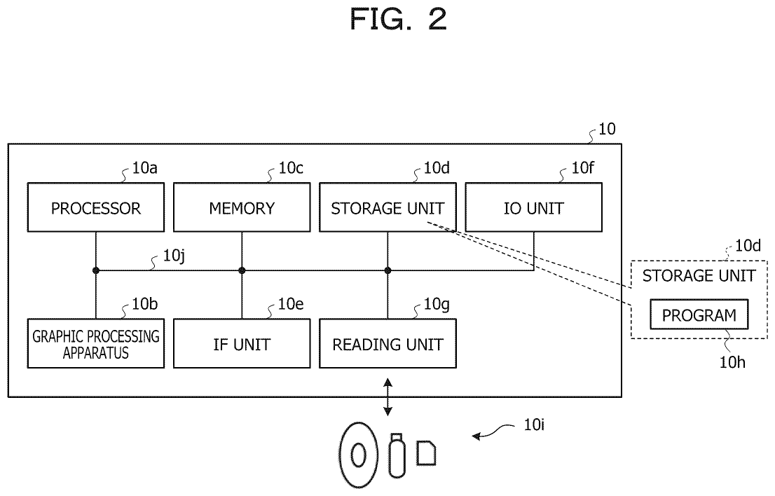

FIG. 2 is a block diagram illustrating a hardware (HW) configuration of a computer 10 that realizes functions of the information processing apparatus 1 serving as the example of the embodiment. As an HW resource for realizing the functions of the information processing apparatus 1, in a case where a plurality of computers are used, each computer may have the HW configuration exemplified in FIG. 2.

As illustrated in FIG. 2, the computer 10 may exemplarily include a processor 10a, a graphic processing apparatus 10b, a memory 10c, a storage unit 10d, an interface (IF) unit 10e, an input/output (IO) unit 10f, and a reading unit 10g, as the HW configuration.

The processor 10a is an example of an arithmetic processing apparatus that performs various controls and arithmetic operations, and is a control unit that executes various processing. The processor 10a may be coupled to each block in the computer 10 via a bus 10j so as to communicate with each other. The processor 10a may be a multiprocessor including a plurality of processors, a multi-core processor including a plurality of processor cores, or a configuration including a plurality of multi-core processors.

Examples of the processor 10a include integrated circuits (ICs) such as a CPU, an MPU, an APU, a DSP, an ASIC, or an FPGA. A combination of two or more of these integrated circuits may be used as the processor 10a. The CPU is an abbreviation for central processing unit, and the MPU is an abbreviation for microprocessor unit. The APU is an abbreviation for accelerated processing unit. The DSP is an abbreviation for digital signal processor. The ASIC is an abbreviation for application-specific IC. The FPGA is an abbreviation for field-programmable gate array.

The graphic processing apparatus 10b performs screen display control for an output device such as a monitor included in the IO unit 10f. The graphic processing apparatus 10b may have a configuration as an accelerator that executes machine learning processing and inference processing using a machine learning model. Examples of the graphic processing apparatus 10b include various arithmetic processing apparatuses, for example, integrated circuits (ICs) such as a graphics processing unit (GPU), an APU, a DSP, an ASIC, or an FPGA.

The memory 10c is an example of HW that stores information such as various types of data and programs. Examples of the memory 10c include one or both of a volatile memory such as a dynamic random-access memory (DRAM) and a nonvolatile memory such as a persistent memory (PM).

The storage unit 10d is an example of HW that stores information such as various types of data or programs. Examples of the storage unit 10d include a magnetic disk apparatus such as a hard disk drive (HDD), a semiconductor drive apparatus such as a solid-state drive (SSD), and various storage apparatuses such as a nonvolatile memory. Examples of the nonvolatile memory include a flash memory, a storage class memory (SCM), a read-only memory (ROM), and the like.

The storage unit 10d may store a program 10h (machine learning program and prediction program) that realizes all or a part of various functions of the computer 10.

For example, the processor 10a of the information processing apparatus 1 may load the program (machine learning program) 10h stored in the storage unit 10d into the memory 10c and execute the program 10h to realize a model generation function (training phase to be described later) of training a machine learning model. The processor 10a of the information processing apparatus 1 loads the program (prediction program) 10h stored in the storage unit 10d into the memory 10c and executes the program 10h, so that a prediction function (prediction phase to be described later) for predicting data by using a machine learning model may be realized.

The IF unit 10e is an example of a communication IF that performs, for example, control of coupling and communication between the computer 10 and another computer. For example, the IF unit 10e may include an adapter that conforms to a local area network (LAN) such as Ethernet (registered trademark) or optical communication such as fibre channel (FC). The adapter may support one or both of a wireless communication method and a wired communication method.

For example, the information processing apparatus 1 may be coupled to another information processing apparatus (not illustrated) via the IF unit 10e and the network so as to be able to communicate with each other. The program 10h may be downloaded from the network to the computer 10 via the communication IF and stored in the storage unit 10d.

The IO unit 10f may include one or both of an input device and an output device. Examples of the input device include a keyboard, a mouse, a touch panel, and the like. Examples of the output device include a monitor, a projector, a printer, and the like. The IO unit 10f may include a touch panel or the like in which an input device and an output device are integrated. The output device may be coupled to the graphic processing apparatus 10b.

The reading unit 10g is an example of a reader that reads information on programs and data recorded in a recording medium 10i. The reading unit 10g may include a coupling terminal or an apparatus to which the recording medium 10i may be coupled or inserted. Examples of the reading unit 10g include an adapter that conforms to Universal Serial Bus (USB) or the like, a drive apparatus that accesses a recording disk, a card reader that accesses a flash memory such as a secure digital (SD) card, or the like. The program 10h may be stored in the recording medium 10i, and the reading unit 10g may read the program 10h from the recording medium 10i and store the program 10h in the storage unit 10d.

Examples of the recording medium 10i include a non-transitory computer-readable recording medium such as a magnetic/optical disk or a flash memory, for example. Examples of the magnetic/optical disk include, for example, a flexible disc, a compact disc (CD), a Digital Versatile Disc (DVD), a Blu-ray disc, a holographic versatile disc (HVD), and the like. Examples of the flash memory include, for example, a semiconductor memory such as a USB memory or an SD card.

The HW configuration of the computer 10 described above is an example. Accordingly, an increase or decrease (for example, addition or deletion of an arbitrary block), division, or integration in an arbitrary combination of the HW in the computer 10, or addition, deletion, or the like of a bus may be appropriately performed.

(B-2) Functional Configuration Example

As illustrated in FIG. 1, the information processing apparatus 1 may exemplarily include functions as a data acquisition unit 2, a constraint function generation unit 3, an optimization unit 4, a prediction execution unit 5, and an output unit 6. These functions may be realized by hardware of the computer 10 (see FIG. 2).

The information processing apparatus 1 has two operation phases of a training (machine learning) phase and a prediction phase. In the training phase, the data acquisition unit 2, the constraint function generation unit 3, and the optimization unit 4 perform learning processing of a machine learning model. In the prediction phase, the prediction execution unit 5 and the output unit 6 predict a class label for input data by using a trained machine learning model.

For example, the data acquisition unit 2 acquires an input of a data set D={xᵢ}ⁿᵢ=1 composed of n feature vectors. For example, the data acquisition unit 2 may acquire the data set D from an input device (not illustrated) to which the data set, which is a data group used for machine learning executed by the information processing apparatus 1, is input. The data set acquired by the data acquisition unit 2 may be an unlabeled data set in which correct data does not exist. The data acquisition unit 2 acquires an input of the number of clusters of clusters to each of which a class label is assigned. The data acquisition unit 2 outputs the acquired number of clusters to the constraint function generation unit 3 and the optimization unit 4. The data acquisition unit 2 outputs the acquired data set to the optimization unit 4.

By using the number of clusters in the clustering to be executed and the machine learning model, the constraint function generation unit 3 generates a function for SAT indicated by Expression (2) described above.

The SAT will be described below. A neural network that performs clustering to be learned is defined by the following Expressions (7) and (8). R^{d} represents a d-dimensional Euclidean space.

f_{θ} [symbol] ^{d}→Δ^{C} (7)

Δ^{C}={z∈ [symbol] ^{C}|z≥, z^{T}1=1} (8)

In Expression (8), Δ^{C} is a set of C-dimensional probability vectors (vectors in which each element is equal to or greater than 0 and the sum of all elements satisfies 1). A bold 1 is a vector having the C dimension and all elements of 1. C represents the number of clusters. z represents a probability density in the C dimension. θ is a parameter existing in the neural network. An output f_{θ} (x) represents a probability with which a data point belongs to each cluster having a range of 1, . . . , and C.

By executing the SAT, the following Expression (9) is satisfied at an arbitrary point x′ within ϵ(>0) centered at the data point x. x′ may be said to be a point having a Euclidean distance close to the data point x.

f_{θ}(x)≈f_{θ}(x′) (9)

For example, by executing the SAT, the output of the neural network is smoothed in the vicinity centered at the data point x.

Assuming that a state of a parameter obtained through t times of stochastic gradient descent (SGD) is θt, the SAT is performed by the following procedure. First, r^{adv} in which a value of gθt (x) is the most different in a meaning of a Kullback Leibler (KL) distance within a radius & centered at the data point x which is an element of R^{d} is specified. Next, θ, which is a parameter of the neural network, is adjusted such that the KL distance between f_{θt} (x) and f₇₄ (x+r^{adv}) approaches. For example, Rᵥₐₜ in Expression (2) is a function that smooths the distribution inside the radius & centered at the data point x. For example, Rᵥₐₜ t in Expression (2) is a function that forces two close data points to have the same class label, and is a function that reduces a distribution distance that is the KL distance between the two data points. Expression (2) is a function representing processing executed in the SAT. A condition that satisfies the function for the SAT is an example of a constraint condition for reducing the distribution distance related to the class label assigned to each of two data points having close Euclidean distance.

The constraint function generation unit 3 generates a constraint expression indicated by the following Expression (10).

$${ℛ}_{vat} ) ℬ ; θ ) = \frac{1}{\vert ℬ \vert} {\sum }_{{x}_{i} ∈ ℬ} {D}_{KL} ( {f}_{{θ}_{l}} ( {x}_{i} ) \vert \vert {f}_{θ} ( {x}_{i} + {r}_{i}^{adv} ) ) \qquad ( 10 )$$

D_{KL} is a Kullback-Leibler divergence. r^{adv}ᵢ is obtained by the following Expression (11).

rᵢ^{adv}=arg max_{∥r∥}_{₂}_{≤ϵ}_{ᵢ} D_{KL} (f_{θ}_{ₗ}(xᵢ+r)) (11)
θₗ is a value obtained in an I-th parameter update.
r^{adv}ᵢ desired for the definition of the above Expression (11) is obtained by the following [Processing a1] to [Processing a3].

[Processing a1]

A random valley vector u ∈ R^{d} is generated.

[Processing a2]

uᵢ indicated below is calculated by a back propagation method.

vᵢ=∇ᵣD_{KL} (f_{θ}_{ₗ}(xᵢ)∥f_{θ}_{ₗ}(xᵢ+r))|_{r=ξu}

[Processing a3]

r^{adv}ᵢ is calculated by using the following Expression.

rᵢ^{adv}=ϵᵢvᵢ/∥vᵢ∥₂

ξ and ϵᵢ are hyper parameters that take positive values.

Under a more mathematically accurate definition, by using a mini-batch set B ⊆ D, the neural network is trained by a stochastic gradient method (SGD) such that a loss indicated by Expression (10) above is minimized.

Hereinafter, the above-described processing executed by the constraint function generation unit 3 may be referred to as Self-Augmentation.

The constraint function generation unit 3 obtains a uniform constraint and a manifold constraint by redefining a normalized cut (NCut) problem by introducing a neural network and a uniform assumption. The constraint function generation unit 3 constructs a method from the NCut problem in order to correspond to a data set having a high-dimensional simple manifold structure.

An instruction function 1 [ω] having an event ω as an argument is defined as follows.

$$1 [ ω ] \{ \begin{matrix}1 , If ω is true \\ 0 , Otherwise\end{matrix}$$

A trace of a matrix A is represented by tr (A).

It is assumed that a data set D={xᵢ}ⁿᵢ₌₁ is given. It is assumed that, as a target, n data points are classified into C clusters. It is assumed that Sy ⊂ D and y ∈ [C] are set as a y-th cluster.

A weighted directed graph G (V, E, W) below is considered. It is assumed that V, E, and W are a vertex set, a directed edge set, and an n×n weight matrix. V=D. It is assumed that a directed edge from xᵢ to xⱼ is defined by eᵢⱼ∈ E.

An (i, j)-th element of W is represented by wᵢⱼ and is a weight over an edge eᵢⱼ. Intuitively, the weight wᵢⱼ may be regarded as a similarity between the vertex xᵢ and the vertex xⱼ.

It is assumed that W=W^{T}. Under this assumption, the graph G may be considered as an undirected graph.

Here, an NCut function having S as an argument over the graph G is defined as indicated by the following Expression (12).

$$NCut ( 𝒮 ) = \frac{{Σ}_{\{ ( i , j ) ; {x}_{i} ∈ 𝒮 \& {x}_{j} ∈ \overline{𝒮} \}} {w}_{ij}}{Vol 𝒮} \qquad ( 12 )$$

Where, it is assumed that S⁻=V\S, and

$$Vol 𝒮 = {\sum }_{\{ i ; {x}_{i} ∈ 𝒮 \}} {\sum }_{\{ j ; {x}_{j} ∈ V \}} {w}_{ij}$$

A combinatorial NCut problem is defined by the following Expression (13).

$$arg {min}_{{𝒮}_{1} , … , {𝒮}_{C}} \frac{2}{C} {\sum }_{y = 1}^{C} NCut ( {𝒮}_{y} ) \qquad ( 13 )$$

It is assumed that D is a diagonal matrix of which diagonal element is dᵢᵢ=ΣⱼWᵢⱼ. It is assumed that H is an n×C matrix in which an (i, y)-th element is h_{iy}. Where, h_{iy} is represented by the following Expression (14).

$${h}_{iy} = \frac{1 [ {x}_{i} ∈ {𝒮}_{y} ]}{\sqrt{Vol {𝒮}_{y}}} \qquad ( 14 )$$

At this time, Σ^{C}_{y=1} Ncut (S_{y})=tr (H^{T} (D-W) H) is established.

Assuming ∀_{y} ∈ [C]; |S_{y}|>0, H^{T}DH=I is established.

|S_{y}| is a density of S_{y}, and I is a unit matrix of C×C. From these facts, when the following continuous relaxation version NCut problem is considered instead of Expression (13), it may be represented as the following Expression (15).

$${min}_{H ∈ {ℝ}^{n \times C}} \frac{2}{C} tr ( {H}^{T} ( D - W ) H ) \\ s . t . {H}^{T} DH = I \qquad ( 15 )$$

It is known that a global optimum solution of Expression (15) is obtained by solving an eigenvalue problem related to W⁻=^{-1/2}WD^{-1/2}. Expression (15) corresponds to a first optimization function that uses NCut.

A set of all data points is represented by X. X={xᵢ}^{N}ᵢ₌₁ may be represented. A relationship between X and an observation data D set is D =X.

A graph Gx is defined. It is assumed that X={xᵢ}^{N}ᵢ₌₁ is given. It is assumed that N<∞. At this time, G_{X} (V, E, W) is an undirected weighted graph defined over X. It is assumed that V, E, and W are a vertex set, an edge set, and an N×N weight matrix. It is assumed that W also satisfies the following condition.

∀(i, j) ∈ [N]²; wᵢⱼ≥0&Σ_{i, j}Wᵢⱼ=1.

Intuitively, wᵢⱼ may be interpreted as a simultaneous occurrence probability of the data point xi and the data point xⱼ in addition to the interpretation of the similarity between the data point xᵢ and the data point Xⱼ.

Arbitrary number C of clusters S₁, . . . , S_{C} are considered over the graph G_{X}. At this time the following Funreccion (16) is established

$$∀ y ∈ [ 𝒞 ] ; Vol {𝒮}_{y} \geq 0 \& {\sum }_{y = 1}^{C} Vol {𝒮}_{y} = 1 \qquad ( 16 )$$

From Expression (16), it is possible to introduce a uniform assumption.

According to the uniform assumption, when the arbitrary number C of clusters (S₁, . . . , Sc) are considered over the graph G_{X}, it is assumed that the clusters satisfy the following condition.

∀_{y} ∈ [C]; VolS_{y}=1/C.

Next, an NCut problem of the neural network is indicated over a graph G_{X}.

Expression (14) described above is redefined by using a neural network f_{θ}:R^{d}→ΔC, and the following [Procedure b1] and [Procedure b2]. [Procedure b1]

Expression (14) described above is redefined by using f_{θ} as indicated in the following Expression (17).

$${h}_{iy} = \frac{{f}_{θ}^{y} ( {x}_{i} )}{\sqrt{Vol {𝒮}_{y}}} \qquad ( 17 )$$

[Procedure b2]

By forcing the uniform assumption described above into Expression (15) described above, rewriting is performed as indicated in the following Expression (18).

$${min}_{θ} {𝔼}_{( {x}_{i} , {x}_{j} ) ∼ {w}_{ij}} [ {‖ {f}_{θ} ( {x}_{i} ) - {f}_{θ} ( {x}_{j} ) ‖}_{2}^{2} ] \\ s . t . ∀ y \neq {y}^{′} ; {𝔼}_{{x}_{i} ∼ {w}_{i}} [ {f}_{θ}^{y} ( {x}_{i} ) {f}_{θ}^{{y}^{′}} ( {x}_{i} ) ] = 0 \\ ∀ y ∈ [ 𝒞 ] ; {𝔼}_{{x}_{i} ∼ {w}_{i}} [ {\{ {f}_{θ}^{y} ( {x}_{i} ) \}}^{2} ] = \frac{1}{C} \qquad ( 18 )$$

Expression (18) is approximated by using observation data D.

It is assumed that the observation data D={xᵢ}ⁿᵢ₌₁ ⊂ X is given. It is assumed that A=(aᵢⱼ)1≤i, j≤n, and aᵢⱼ ∈ {0, 1} are set as a partially symmetric adjacency matrix of n×n. When the simultaneous occurrence probability wᵢⱼ of the pair of xᵢ and xⱼ is larger than a certain constant δ, aᵢⱼ is 1, and when it is equal to or smaller than the constant δ, aᵢⱼ is 0.

A may be estimated by using a K-NN (K-nearest neighbors algorithm) graph. It is assumed that A\hat{ } is an estimated adjacency matrix. At this time, the following is an estimation example.

For example, over D={xᵢ}ⁿᵢ₌₁, the K-NN graph is defined by using Euclidean distance. An n×n matrix of A\hat{ }=(a\hat{ }ᵢⱼ), 1≤i, and j≤ n is prepared. When one of K neighbors of xⱼ is xᵢ, 1 is substituted into a\hat{ }ᵢⱼ, and when it is not, 0 is substituted into a\hat{ }ᵢⱼ.

A\hat{ } is redefined by using the following Expression (19).

Â←Â+Â^{T}−Â⊙Â^{T} (19)

⊙ is a Hadamard product.

It is assumed that A is obtained through the estimation indicated in Expression (19). At this time, it is considered to approximate Expression (18) by using a mini-batch set B (∈ D) and the estimated A. An index iᵢ, i ∈ [|B|] satisfying the following is considered.

Xᵢᵢ ∈ B&∀ᵢ, ≤yᵢ₊₁

It is assumed that A_{B}=(a^{˜}_{ii′})_{1≤i, i≤|B|} is a matrix of |B|×|B|. Where, the (i, i′)-th element a^{˜}_{ii′} is a_{iiIi′}. At this time, Expression (18) is approximated by the following Expressions (20) to (22).

$$\begin{matrix}{min}_{θ} 𝒬 ( ℬ ; θ ) ≡ \frac{1}{{‖ {A}_{ℬ} ‖}_{1}} {\sum }_{\{ ( i , {i}^{′} ) ; {\overline{a}}_{{ii}^{′}} = 1 \}} {‖ {f}_{θ} ( {x}_{i} ) - {f}_{θ} ( {x}_{{i}_{{i}^{′}}} ) ‖}_{2}^{2} & ( 20 ) \\ s . t . ∀ y \neq {y}^{′} ; \frac{1}{\vert ℬ \vert} {\sum }_{{x}_{i} ∈ ℬ} {f}_{θ}^{y} ( {x}_{i} ) {f}_{θ}^{{y}^{′}} ( {x}_{i} ) = 0 & ( 21 ) \\ ∀ y ∈ [ 𝒞 ] ; \frac{1}{\vert ℬ \vert} {\sum }_{{x}_{i} ∈ ℬ} {\{ {f}_{θ}^{y} ( {x}_{i} ) \}}^{2} = \frac{1}{C} & ( 22 )\end{matrix}$$

∥A_{B}∥=Σ_{i, i′}|a^{˜}_{ii′}|, and this is equal to the number of non-zero elements in A_{B}.

It is assumed that M_{θ}={θ||Expression (21) & Expression (22)}. For the mini-batch set B ⊆ D, p_{θ}(y) and y ∈ [C] are defined as follows.

$${p}_{θ} ( y ) = \frac{1}{\vert ℬ \vert} {Σ}_{{x}_{i} ∈ ℬ} {f}_{θ}^{y} ( {x}_{i} )$$

It is defined as in the following Expressions (23) and (24).

$$\begin{matrix}{ℍ}_{ℬ} ( {p}_{θ} ( y ) ) = - {\sum }_{y = 1}^{C} {p}_{θ} ( y ) log {p}_{θ} ( y ) & ( 23 ) \\ ℍ ( {f}_{θ} ( x ) ) = - {\sum }_{y = 1}^{C} {f}_{θ}^{y} ( x ) log {f}_{θ}^{y} ( x ) & ( 24 )\end{matrix}$$

M′_{θ} is defined as indicated by the following Expression (25).

$${ℳ}_{θ}^{′} = \{ θ \vert {ℍ}_{ℬ} ( {p}_{θ} ( y ) ) = log C \& \frac{1}{\vert ℬ \vert} {\sum }_{{x}_{i} ∈ ℬ} ℍ ( {f}_{θ} ( {x}_{i} ) ) = 0 \} \qquad ( 25 )$$

At this time, M_{θ}=M′_{θ} is established. Expression (25) may be referred to as an equivalent modification of Expression (21) and Expression (22).

An (l+1)-th parameter update is considered for the mini-batch set B ⊆ D. For simplicity, the definition indicated in the following Expression (26) is introduced.

$$\begin{matrix}𝒰 ( y , {y}^{′} ) = \frac{1}{\vert ℬ \vert} {\sum }_{{x}_{i} ∈ ℬ} {f}_{θ}^{y} ( {x}_{i} ) {f}_{θ}^{{y}^{′}} ( {x}_{i} ) \\ 𝒱 ( y ) = \frac{1}{\vert ℬ \vert} {\{ {f}_{θ}^{y} ( {x}_{i} ) \}}^{2} .\end{matrix} \} \qquad ( 26 )$$

The constraint function generation unit 3 generates the following Expression (27) by using Expression (20), Expression (21), and Expression (22).

$$\underbrace{{ℛ}_{vat} ( ℬ ; θ )}_{Self - Augmentation} + λ ( {\frac{η}{C} \underbrace{𝒬 ( ℬ ; θ )}}_{Manifold Constraint} + \underbrace{μ {\sum }_{y = 1}^{C} {( 𝒱 ( y ) - 1 / C )}^{2} + {\sum }_{y , {y}^{′}} {𝒰}^{2} ( y , {y}^{′} )}_{Uniform Constraint} ) \qquad ( 27 )$$

{λ, η, μ} ∈ R³₊ is a set of hyper parameters. Definitions of Rᵥₐₜ (B;θ), H_{B} (p_{θ} (y)), and H (f_{θ} (xᵢ)) are given by Expression (10), Expression (23), and Expression (24), respectively.

In Expression (27), a term of Rvat (B;θ) is a constraint function based on Self-Augmentation. A term of Q (B;θ) is a constraint function based on a manifold constraint. The following term is a constraint function based on a uniform constraint, which enables the NCut problem to be implemented by the neural network.

$$μ {\sum }_{y = 1}^{C} {( v ( y ) - \frac{1}{C} )}^{2} + {\sum }_{y , {y}^{′}} {u}^{2} ( y , {y}^{′} )$$

The constraint function generation unit 3 generates an optimization function based on the constraint function based on Self-Augmentation, the constraint function based on the manifold constraint, and the constraint function based on the uniform constraint.

The constraint function generation unit 3 notifies the optimization unit 4 of the generated Expression (27).

Instead of generating Expression (27), the constraint function generation unit 3 may generate Expression (28) indicated below by using Expression (20) and Expression (25) described above.

$${R}_{vat} ( B ; θ ) + λ [ \frac{η}{C} Q ( B ; θ ) - {μℍ}_{B} ( {p}_{θ} ( y ) ) - \frac{1}{\vert B \vert} {\sum }_{y , {y}^{′}} ℍ ( {f}_{θ} ( {x}_{i} ) ) ] \qquad ( 28 )$$

In Expression (28), the term of the constraint function based on the uniform constraint is different from that in Expression (27), and other parts are the same as those in Expression (27). In Expression (28), the definitions of HB (p_{θ} (y)) and H (f_{θ} (xi)) are given by Expression (23) and Expression (24), respectively.

Both Expression (27) and Expression (28) described above correspond to a second optimization function generated by converting Expression (15), which is the first optimization function that uses NCut, based on the introduction of the neural network and the uniform assumption for the cluster in clustering.

The constraint function generation unit 3 may notify the optimization unit 4 of the generated Expression (28).

The optimization unit 4 receives the function indicated by Expression (27) or the function indicated by Expression (28) from the constraint function generation unit 3. The optimization unit 4 performs training of a machine learning model (optimization of a neural network) so as to minimize the function indicated by Expression (27) or the function indicated by Expression (28).

According to the learning result, the optimization unit 4 adjusts and optimizes the parameters of the machine learning model. The optimization unit 4 repeats learning of the machine learning model until learning processing converges or learning processing is completed a predetermined number of times. After that, when the learning processing converges or the learning processing is completed the predetermined number of times, the optimization unit 4 gives the obtained parameters to the machine learning model to generate a learned machine learning model.

For example, the prediction execution unit 5 receives input of data to be predicted from an external apparatus (not illustrated). The prediction execution unit 5 inputs the data to be predicted to the neural network of the learned machine learning model, and acquires information on a class label corresponding to the data to be predicted output as the prediction result. The prediction execution unit 5 outputs the acquired class label to the output unit 6.

From the prediction execution unit 5, the output unit 6 acquires the information on the class label corresponding to the input data to be predicted. The output unit 6 outputs the information on the class label corresponding to the data to be predicted.

(C) Operation

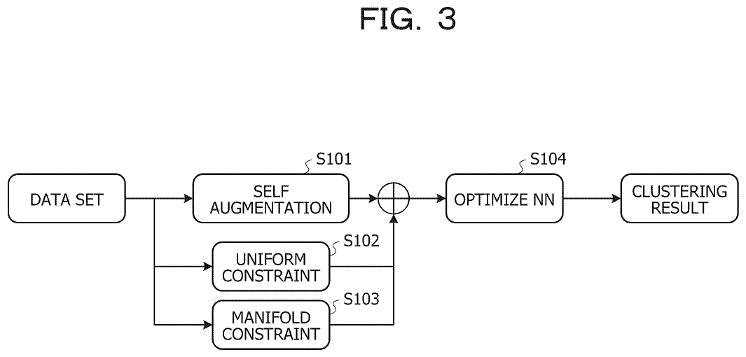

FIG. 3 is a diagram for explaining a flow of learning processing by the information processing apparatus 1 as an example of the embodiment. An overview of the learning processing by the information processing apparatus 1 according to the present example will now be described with reference to FIG. 3.

Self-Augmentation by the constraint function generation unit 3 is performed on the data set acquired by the data acquisition unit 2, and a constraint expression indicated in Expression (10) is generated (step S101).

The constraint function generation unit 3 generates a constraint function based on the uniform constraint and a constraint function based on the manifold constraint (steps S102 and S103). The constraint function generation unit 3 generates Expression (27) or Expression (28) including the constraint function based on Self-Augmentation, the constraint function based on the manifold constraint, and the constraint function based on the uniform constraint.

The optimization unit 4 adjusts the parameters (λ, η, μ) so as to minimize the function indicated by Expression (27) or the function indicated by Expression (28), and performs learning of a machine learning model (optimization of a neural network) (step S104).

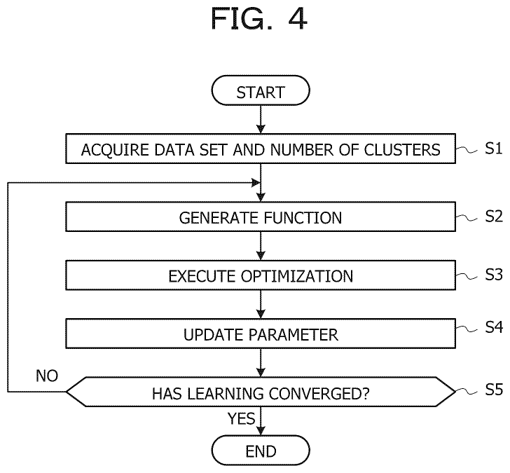

Next, learning processing of a statistical model by the information processing apparatus according to the example will be described below with reference to a flowchart (steps S1 to S5) indicated in FIG. 4.

The data acquisition unit 2 acquires a data set and the number of clusters (step S1). The data acquisition unit 2 notifies the constraint function generation unit 3 and the optimization unit 4 of the number of clusters. The data acquisition unit 2 outputs the data set to the optimization unit 4.

The constraint function generation unit 3 acquires a machine learning model and uses the number of clusters to generate a function for SAT represented by Expression (10). The constraint function generation unit 3 generates a constraint function based on a manifold constraint and a constraint function based on a uniform constraint. The constraint function generation unit 3 generates Expression (27) or Expression (28) including the constraint function based on Self-Augmentation, the constraint function based on the manifold constraint, and the constraint function based on the uniform constraint (step S2).

The optimization unit 4 adjusts the hyper parameters (λ, η, μ) so as to minimize the function indicated by Expression (27) or the function indicated by Expression (28), and performs learning of the machine learning model (optimization of the neural network) (step S3).

After that, the optimization unit 4 updates parameters of the machine learning model with the parameters obtained by the optimization (step S4).

Next, the optimization unit 4 determines whether the learning has converged (step S5). When the learning has not converged (see NO route in step S5), the learning processing returns to step S2. By contrast, when the learning has converged (see YES route in step S5), the optimization unit 4 ends the learning processing.

(D) Effect

As described above, according to the information processing apparatus 1 as the example of the embodiment, the constraint function generation unit 3 converts (redefines) Expression (15) (first optimization function) based on NCut based on the introduction of the neural network and the uniform assumption for the cluster in the clustering to generate Expression (27) or Expression (28) which is the second optimization function. For example, the constraint function generation unit 3 generates an optimization function (Expression (27) and Expression (28): second optimization function) based on the constraint function based on Self-Augmentation, the constraint function based on the manifold constraint, and the constraint function based on the uniform constraint.

By adjusting the hyper parameters (λ, η, μ) so as to minimize the function indicated by Expression (27) or the function indicated by Expression (28), the optimization unit 4 performs training of the machine learning model.

At this time, since the number of hyper parameters to be adjusted by the optimization unit 4 is as small as three, it is possible to shorten the time taken for training and improve the efficiency. The calculation cost may be reduced.

By the constraint function generation unit 3 redefining the NCut problem by introducing the neural network and the uniform assumption, it is possible to obtain the uniform constraint and the manifold constraint, and to reduce the number of hyper parameters. By constructing a method from the NCut problem, it is possible to realize high-accuracy clustering for a data set having a low-dimensional complex manifold structure.

Accordingly, it is possible to realize high-accuracy clustering for a data set having a low-dimensional simple manifold structure, a data set having a low-dimensional complex manifold structure, and a data set having a high-dimensional simple manifold structure.

For example, it is possible to increase the speed of clustering for large-scale data. This is because the uniform assumption and the neural network are introduced into the NCut problem and redefined, and the redefined problem may be solved by an existing optimization method of the neural network.

It is possible to realize clustering with higher accuracy for a data set having a high-dimensional simple manifold structure. This is because an expression power is improved by introducing the neural network.

In the method of the information processing apparatus 1, since the constraint function generation unit 3 performs the formulating, the mini-batch optimization may be applied, and a memory capacity taken for the calculation may be reduced.

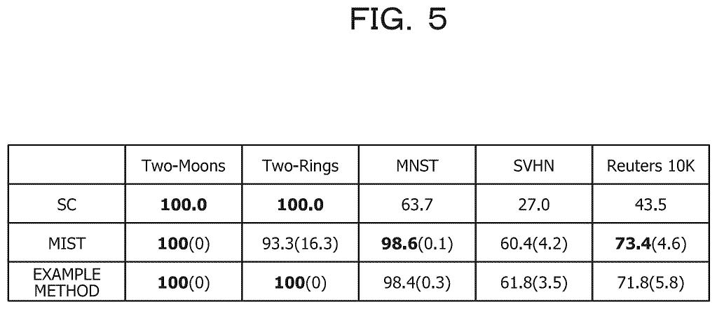

FIG. 5 is a diagram illustrating respective clustering results in a case where a plurality of methods are used. Two data sets of Two-Moons and Two-Rings have been used as data sets of a low-dimensional and complex manifold structure. As data sets of high-dimensional and simple manifold structure, three data sets of Modified National Institute of Standards and

Technology dataset (MNIST), street view house numbers (SVHN), and Reuters 10K have been used.

As a clustering method for comparison, the following method has been used. Spectral clustering (SC) has been used as a classical clustering method. As a deep clustering method, Mutual Information maximization with local Smoothness and Topologically invariant constraints (MIST) has been used. FIG. 5 illustrates the clustering method by the information processing apparatus 1 according to the present embodiment as “Example Method”.

An evaluation index represents an average clustering accuracy when clustering is performed seven times with the highest value of the clustering accuracy as 100%. The numbers in parentheses in FIG. 5 represent standard deviations.

As illustrated in FIG. 5, the clustering method by the information processing apparatus 1 according to the present example have achieved clustering results equal to or higher than those of the classical clustering method and the deep clustering method in almost all data sets.

(E) Others

Each configuration and each processing of the present embodiment may be selectively employed or omitted as desired, or may be combined as appropriate.

The disclosed technique is not limited to the above-described embodiment. The present embodiment may be carried out while being modified in various ways within a scope not departing from the gist of the present embodiment.

The above-described disclosure enables a person skilled in the art to carry out and manufacture the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process, the process comprising:
in training a machine learning model that performs clustering of a data group,
generating a second optimization function by converting a first optimization function that uses normalized cut (NCut) based on an introduction of a neural network and a uniform assumption for a cluster in the clustering; and
executing the training of the machine learning model by executing processing of optimizing the second optimization function.

2. The non-transitory computer-readable recording medium according to claim 1, wherein
in the generating of the second optimization function, generating a constraint function based on a manifold constraint and including the constraint function in the second optimization function.

3. A machine learning method performed by a computer, the method comprising:
in training a machine learning model that performs clustering of a data group,
generating a second optimization function by converting a first optimization function that uses normalized cut (NCut) based on an introduction of a neural network and a uniform assumption for a cluster in the clustering; and
executing the training of the machine learning model by executing processing of optimizing the second optimization function.

4. The machine learning method according to claim 3, wherein
in the generating of the second optimization function, generating a constraint function based on a manifold constraint and including the constraint function in the second optimization function.

5. An information processing apparatus comprising:
a memory, and
a processor coupled to the memory and configured to:
in training a machine learning model that performs clustering of a data group,
generate a second optimization function by converting a first optimization function that uses normalized cut (NCut) based on an introduction of a neural network and a uniform assumption for a cluster in the clustering; and
execute the training of the machine learning model by executing processing of optimizing the second optimization function.

6. The information processing apparatus according to claim 5, wherein
in the generate of the second optimization function, generate a constraint function based on a manifold constraint and include the constraint function in the second optimization function.
